(19) United States
(12) Patent Application Publication
(10) Pub. No.: US 2012/0133876 A1
(43) Pub. Date: May 31, 2012

(54) LIQUID CRYSTAL PANEL

(75) Inventors: Hiroki Nakahama, Osaka (JP); Keigo Aoki, Osaka (JP); Gen Nagaoka, Osaka (JP); Kiyoshi Inada, Osaka (JP); Motoji Shiota, Osaka (JP)

(73) Assignee: SHARP KABUSHIKI KAISHA, Osaka (JP)

(21) Appl. No.: 13/262,216

(22) PCT Filed: Jan. 15, 2010
(86) PCT No.: PCT/JP2010/050395

§ 371 Date: Nov. 1, 2011

(30) Foreign Application Priority Data
Mar. 31, 2009 (JP) 2009-086402

(51) Int. Cl. G02F 1/1343

(52) U.S. Cl. 349/139

(57) ABSTRACT

A region for mounting components such as an IC chip is sufficiently ensured on a glass substrate with which a liquid crystal panel is configured, without reducing the number of panel pieces to be taken from a large panel. A liquid crystal panel is composed of a first glass substrate (10) and a second glass substrate (20) which face each other with a liquid crystal therebetween. The first glass substrate (10) and the second glass substrate (20) are formed in substantially the same size in plan view and bonded together in a state in which these substrates are shifted from each other by a predetermined distance in the direction of the longer side or in the direction of the shorter side. Regions to become a frame (frame regions) are provided on both the first glass substrate (10) and the second glass substrate (20), and pads (60) are provided on both of these frame regions.

### TECHNICAL FIELD

The present invention relates to a liquid crystal panel, and more particularly to the structure of a liquid crystal panel.

### BACKGROUND ART

A liquid crystal panel is generally composed of two mutually facing glass substrates. One of the glass substrates (hereinafter referred to as “first glass substrate”) is called a “TFT substrate,” “array substrate,” “TFT array substrate,” or the like, and thin-film transistors (TFTs), pixel electrodes, and the like that are disposed in a matrix are formed on a mother glass substrate. The other glass substrate (hereinafter referred to as “second glass substrate”) is called a “color filter substrate,” “opposite substrate,” or the like, and RGB colored layers, transparent electrodes, and the like are formed on a mother glass substrate. The first glass substrate and the second glass substrate are bonded with each other by a sealing material so as to hold a liquid crystal therebetween. With regard to the substrate size, the first glass substrate is generally formed to be larger than the second glass substrate. This is because, from the entire region on the first glass substrate, the region that does not face the second glass substrate is utilized as a region for mounting an IC chip or the like for driving the liquid crystal. Such a region has been conventionally provided in the marginal portion of the liquid crystal panel and is therefore called a “frame.” Note that there are also cases in which a circuit for driving the liquid crystal is formed monolithically in a region to become a frame (hereinafter referred to as “frame area”) or in which a flexible printed circuit (FPC) for mounting components such as an IC chip is connected to the frame area.

Incidentally, with regard to liquid crystal panels, a large panel is manufactured by bonding large mother glass substrates with each other, after which panel pieces (individual liquid crystal panels) are manufactured by dividing (cutting) this large panel. While panel pieces are manufactured in this manner, it has been attempted in recent years to increase the number of panel pieces to be taken from a large panel, so the frame area is gradually becoming smaller.

Note that the following prior art is known in relation to the invention of the present application. Japanese Utility Model Registration Publication No. 3095624 discloses a configuration in which a signal scan control IC is provided on one end of a liquid crystal panel, while a data transfer control IC is provided on the other end, i.e., a configuration in which frame areas are provided on both one end and the other end of the liquid crystal panel. Japanese Patent Application Laid-Open Publication No. H6-273789 discloses a technique of reducing the size of a liquid crystal display device by making a frame portion smaller and thinner. Japanese Patent Application Laid-Open Publication No. H8-122745 discloses a configuration in which driver ICs are mounted by means of chip-on-glass mounting along two sides (commonly along the two long sides) of a liquid crystal display panel. Japanese Patent Application Laid-Open Publication No. 2007-264366 discloses a technique of narrowing the frame and expanding the effective display region with respect to a liquid crystal display device.

### RELATED ART DOCUMENTS

### Patent Documents

Patent Document 1: Japanese Utility Model Registration Publication No. 3095624

Patent Document 2: Japanese Patent Application Laid-Open Publication No. H6-273789

Patent Document 3: Japanese Patent Application Laid-Open Publication No. H8-122745

Patent Document 4: Japanese Patent Application Laid-Open Publication No. 2007-264366

### SUMMARY OF THE INVENTION

### Problems to be Solved by the Invention

As described above, the frame area of a liquid crystal panel is gradually becoming smaller. The effect of such narrowing of a frame will be described with reference to FIG. 24. FIG. 24(A) is a plan view showing an example of a liquid crystal panel configuration prior to the frame narrowing. FIG. 24(B) is a plan view showing an example of a liquid crystal panel configuration following the frame narrowing. When the length of the frame area in the direction of the longer side of the entire panel is reduced from L91 to L92, it may be impossible in some cases “for all of the components mounted in the frame area prior to the frame narrowing to be also mounted in the frame area (after the frame narrowing).” In such cases, a portion of the components indicated by the reference character 90 in FIG. 24(A) ends up being mounted on an FPC following the frame narrowing. That is, many components must be mounted on the FPC after the frame narrowing, as compared to before frame narrowing, as indicated by the reference character 91 in FIG. 24(B). For this reason, although the size of the liquid crystal panel overall is reduced by the frame narrowing, the size of the FPC for mounting the components may be increased.

Incidentally, with regard to the FPC as well, as in the liquid crystal panel, FPC pieces (individual FPCs) are manufactured by dividing a large FPC sheet. Therefore, when the size of FPC pieces is increased by the frame narrowing of the liquid crystal panel as described above, the number of FPC pieces to be taken from a large FPC sheet is reduced. As a result, the cost is increased.

In light of this, the present invention has as its object to ensure a sufficient region for mounting components such as an IC chip on a glass substrate with which a liquid crystal panel is configured without reducing the number of panel pieces to be taken from a large panel.

### Means for Solving the Problems

A first aspect of the present invention is a liquid crystal panel formed from a first substrate having a first wiring surface on which electrical wiring is formed and a second substrate having a second wiring surface on which electrical wiring is formed, with the aforementioned first substrate and the aforementioned second substrate being bonded with each other such that a portion of the region on the aforementioned first wiring surface and a portion of the region on the aforementioned second wiring surface face each other, wherein

the aforementioned second wiring surface is formed in substantially the same size as the aforementioned first wiring surface, and

the aforementioned first wiring surface and the aforementioned second wiring surface face each other with a liquid crystal therebetween in a state in which these wiring surfaces are shifted from each other by a predetermined distance in the direction of the longer side or in the direction of the shorter side.

A second aspect of the present invention is the first aspect of the present invention, wherein

one or more electrodes are provided in both a first frame region which is, in the region on the aforementioned first wiring surface, a region that does not face the aforementioned second wiring surface and a second frame region which is, in the region on the aforementioned second wiring surface, a region that does not face the aforementioned first wiring surface.

A third aspect of the present invention is the second aspect of the present invention, wherein

the aforementioned first wiring surface and the aforementioned second wiring surface are formed such that the wiring resistance in the aforementioned second wiring surface is greater than the wiring resistance in the aforementioned first wiring surface, and

a circuit for driving the aforementioned liquid crystal is formed in the aforementioned first frame region.

A fourth aspect of the present invention is the second aspect of the present invention, wherein

at least one of the electrodes provided in the aforementioned second frame region is connected to a third substrate having electrical wiring.

A fifth aspect of the present invention is the fourth aspect of the present invention, wherein

a light-emitting diode is provided in the aforementioned second frame region, and the aforementioned light-emitting diode and the aforementioned third substrate are electrically connected via the electrical wiring formed on the aforementioned second wiring surface.

A sixth aspect of the present invention is the fourth aspect of the present invention, wherein

a sensor chip is provided in the aforementioned second frame region, and the aforementioned sensor chip, and the aforementioned third substrate are electrically connected via the electrical wiring formed on the aforementioned second wiring surface.

A seventh aspect of the present invention is the second aspect of the present invention, wherein

at least one of the electrodes provided in the aforementioned first frame region is connected to a flexible printed board.

An eighth aspect of the present invention is the second aspect of the present invention, wherein

at least one of the electrodes provided in the aforementioned second frame region is connected to an integrated circuit chip.

A ninth aspect of the present invention is the second aspect of the present invention, wherein

at least one of the electrodes provided in the aforementioned second frame region is connected to a flexible printed board.

A tenth aspect of the present invention is the second aspect of the present invention, wherein

at least one of the electrodes provided in the aforementioned first frame region is connected directly or via a flexible printed board to a fourth substrate which is a main board for communication functions, and

at least one of the electrodes provided in the aforementioned second frame region is connected directly or via a flexible printed board to a fifth substrate which is a sub-board on which a component for communication functions is mounted.

### Effects of the Invention

According to the first aspect of the present invention, the first wiring surface and the second wiring surface are formed in substantially the same size, and the first wiring surface and the second wiring surface face each other in a state in which these wiring surfaces are shifted from each other in the direction of the longer side or in the direction of the shorter side. Therefore, regions that can be utilized as a frame (frame regions) are provided on both the first substrate and the second substrate. Incidentally, the portion corresponding to the frame region provided on the second substrate corresponds to the portion that was discarded in the past. From the foregoing, without making the number of panel pieces to be taken from a large panel smaller than in the past, the frame region can be nearly doubled compared to the conventional configuration, so more components can be mounted on the glass substrates constituting the liquid crystal panel than in the past. Consequently, components that were mounted on an FPC (flexible printed board) or the like in the conventional configuration can be mounted on the glass substrates. Accordingly, the size of the FPC or the like can be made smaller than in the conventional configuration, so the cost is reduced.

According to the second aspect of the present invention, one or more electrodes are provided in both a first frame region and a second frame region. Therefore, more components can be mounted on the glass substrates constituting the liquid crystal panel via such electrodes than in the conventional configuration.

According to the third aspect of the present invention, more components can be mounted on the glass substrates constituting the liquid crystal panel than in the conventional configuration without affecting the driving of the liquid crystal.

According to the fourth aspect of the present invention, the second frame region is connected to a third substrate having electrical wiring. Therefore, it is possible to devise a configuration in which control signals are supplied to components mounted in the second frame region via the electrical wiring formed on the third substrate instead of devising a configuration in which control signals are supplied via the electrical wiring within the liquid crystal panel. Consequently, control signals are supplied to the components within the second frame region via electrical wiring that has a smaller resistance than the electrical wiring within the liquid crystal panel, so power consumption is suppressed.

According to the fifth aspect of the present invention, the frame regions on the glass substrates are efficiently used in a liquid crystal panel provided with a light-emitting diode. Furthermore, it is possible to devise a configuration in which control signals are supplied to the light-emitting diode via the electrical wiring formed on the third substrate, so power consumption is suppressed as in the fourth aspect of the present invention.

According to the sixth aspect of the present invention, the frame regions on the glass substrates are efficiently used in a liquid crystal panel provided with a sensor chip. Moreover, because a configuration is possible in which control signals are supplied to the sensor chip via the electrical wiring formed on the third substrate, power consumption is suppressed as in the fourth aspect of the present invention.

According to the seventh aspect of the present invention, an effect similar to that of the second aspect of the present invention can be obtained in a liquid crystal panel configured such that a flexible printed board is connected to the first frame region.

According to the eighth aspect of the present invention, an effect similar to that of the second aspect of the present invention can be obtained in a liquid crystal panel configured such that an integrated circuit chip is mounted in the second frame region.

According to the ninth aspect of the present invention, an effect similar to that of the second aspect of the present invention can be obtained in a liquid crystal panel configured such that a flexible printed board is connected to the second frame region.

According to the tenth aspect of the present invention, it is possible to devise a configuration in which a main board for communication functions provided in the vicinity of the first frame region and a sub-board for communication functions provided in the vicinity of the second frame region are electrically connected via the electrical wiring within the liquid crystal panel. Therefore, a substrate for communication functions becomes unnecessary in the portion corresponding to the display region of the liquid crystal panel, thus making it possible to lower the profile and reduce the cost of an electronic device having communication functions.

### BRIEF DESCRIPTION OF THE DRAWINGS

FIG. 1 is a sectional view of a liquid crystal panel according to a first embodiment of the present invention.

FIGS. 2(A) and 2(B) are diagrams for illustrating the difference between a conventional configuration and the basic configuration of the present invention.

FIG. 3 is a diagram for illustrating the basic configuration of the present invention.

FIG. 4 is a plan view of a liquid crystal panel according to the aforementioned first embodiment.

FIG. 5 is a schematic plan view for illustrating the configuration of regions outside the display area in the aforementioned first embodiment.

FIG. 6 is a sectional view of a liquid crystal panel according to a second embodiment of the present invention.

FIG. 7 is a schematic plan view for illustrating the configuration of regions outside the display area in the aforementioned second embodiment.

FIG. 8 is a sectional view of a liquid crystal panel according to a third embodiment of the present invention.

FIG. 9 is a schematic plan view for illustrating the configuration of regions outside the display area in the aforementioned third embodiment.

FIG. 10 is a sectional view of a liquid crystal panel according to a fourth embodiment of the present invention.

FIG. 11 is a schematic plan view for illustrating the configuration of regions outside the display area in the aforementioned fourth embodiment.

FIG. 12 is a sectional view of a liquid crystal panel according to a fifth embodiment of the present invention.

FIG. 13 is a schematic plan view for illustrating the configuration of regions outside the display area in the aforementioned fifth embodiment.

FIG. 14 is a sectional view of a liquid crystal panel according to a sixth embodiment of the present invention.

FIG. 15 is a schematic plan view for illustrating the configuration of regions outside the display area in the aforementioned sixth embodiment.

FIG. 16 is a sectional view showing a configuration in which control signals are supplied to the LEDs via wiring formed on the third substrate in the aforementioned sixth embodiment.

FIG. 17 is a sectional view of a liquid crystal panel according to a seventh embodiment of the present invention.

FIG. 18 is a schematic plan view for illustrating the configuration of regions outside the display area in the aforementioned seventh embodiment.

FIG. 19 is a sectional view showing a configuration in which exchange of input and output signals between a sensor chip and a control portion or the like is performed via wiring formed on the third substrate in the aforementioned seventh embodiment.

FIG. 20 is a sectional view of a liquid crystal panel according to an eighth embodiment of the present invention.

FIG. 21 is a schematic plan view for illustrating the configuration of regions outside the display area in the aforementioned eighth embodiment.

FIG. 22 is a diagram for illustrating a conventional configuration of a mobile phone provided with a speaker.

FIG. 23 is a diagram for illustrating the configuration of a mobile phone provided with a speaker in the aforementioned eighth embodiment.

FIGS. 24(A) and 24(B) are diagrams for illustrating the effect of the frame narrowing.

### DETAILED DESCRIPTION OF EMBODIMENTS

### 1. Basic Configuration

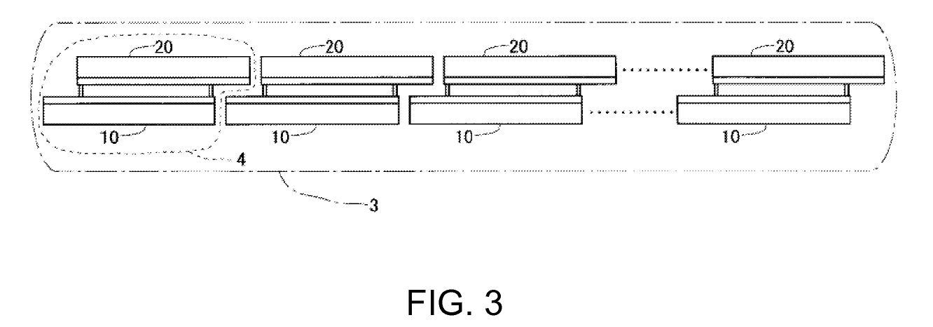

First, the basic configuration that is common to all of the embodiments of the present invention will be described while making a comparison to a conventional configuration. FIG. 2(A) is a sectional view of liquid crystal panels (two panel pieces) in a conventional configuration. Each of these liquid crystal panels is composed of two glass substrates (a first glass substrate 10 and a second glass substrate 28) that face each other with a liquid crystal therebetween. Wiring (electrical wiring) 14 and 24 for driving the liquid crystal is respectively formed on the two glass substrates 10 and 28, and the two glass substrates 10 and 28 are bonded together by a sealing material 50 such that the surfaces on which such wiring 14 and 24 is formed face each other. As described above, because panel pieces are manufactured by dividing a large panel, a portion 29 of the second glass substrate that faces the first glass substrate 10 is cut off and discarded as shown in FIG. 2(A). Then, from the region on the first glass substrate 10, the region that faces this discarded portion 29 is utilized as a frame. FIG. 2(B) is a sectional view of liquid crystal panels (two panel pieces) in the basic configuration of the present invention. In this basic configuration as well, as in the conventional configuration, each of the liquid crystal panels is composed of two glass substrates that face each other with a liquid crystal therebetween. In this basic configuration, however, the portion 29 that has been discarded in the conventional configuration is not cut off, and this portion 29 is utilized as a frame. That is, with this basic configuration, a region to become a frame (hereinafter referred to as “first frame area”) 12 is provided on the first glass substrate 10, and a region to become a frame (hereinafter referred to as “second frame area”) 22 is also provided on the second glass substrate 20. Note that in order to form such a configuration, in the division of a large panel 3 into panel pieces 4, each of the glass substrates 10 and 20 is cut so as to create a state in which the first glass substrate 10 and the second glass substrate 20 are bonded together while being shifted from each other when attention is focused on each of the panel pieces 4 as shown in FIG. 3.

Thus, with this basic configuration, the region that can be utilized as a frame is nearly doubled in each of the panel pieces compared to the conventional configuration. Therefore, more components (such as an IC chip) can be mounted on the glass substrates constituting a liquid crystal panel than in the conventional configuration. Furthermore, because the portions that have been discarded in the conventional configuration are utilized as the frame areas, the number of the panel pieces to be taken from a large panel is not reduced.

Embodiments of the present invention that presuppose the aforementioned basic configuration will be described below.

### 2. Embodiments

### 2.1 First Embodiment

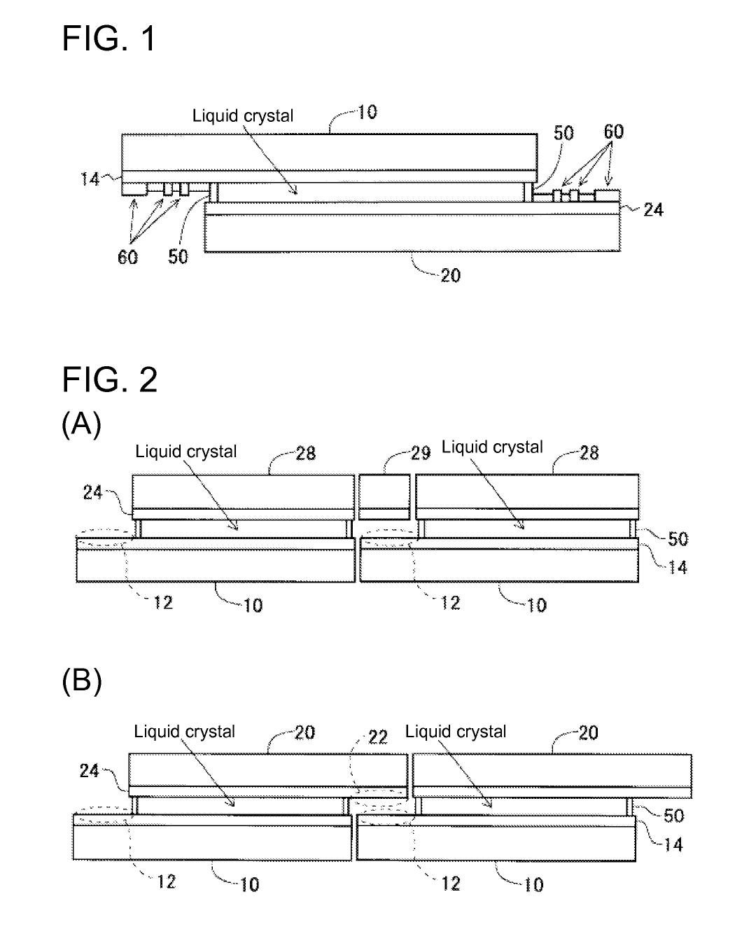

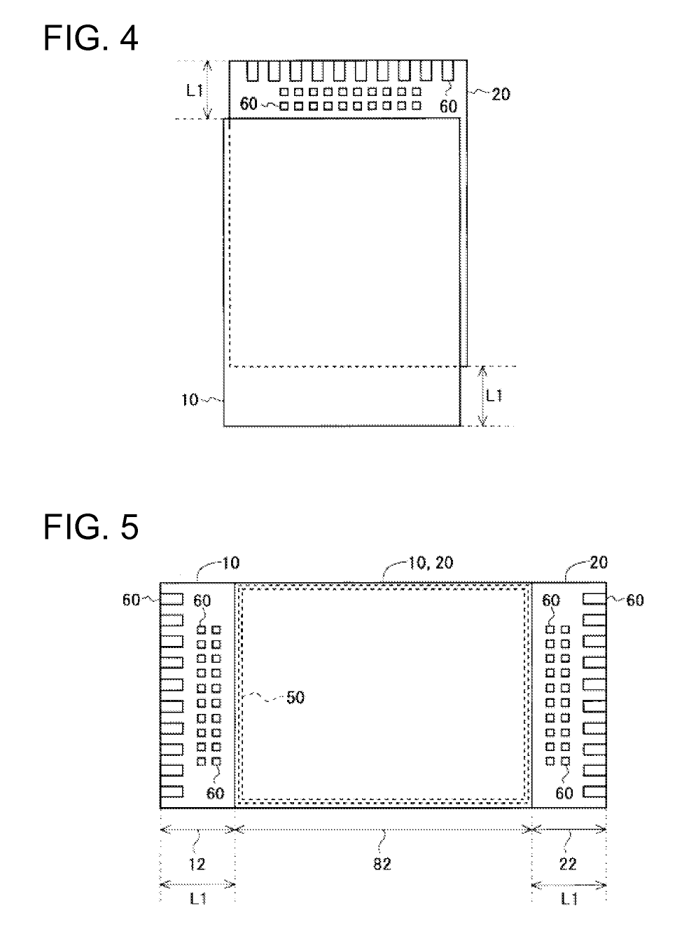

FIG. 1 is a sectional view of a liquid crystal panel according to a first embodiment of the present invention. FIG. 4 is a plan view of the liquid crystal panel according to the present embodiment. As is shown in FIG. 1, this liquid crystal panel is composed of a first glass substrate 10 and a second glass substrate 20 that face each other with a liquid crystal therebetween. Wiring 14 and 24 for driving the liquid crystal is respectively formed on the two glass substrates 10 and 20, and the two glass substrates 10 and 20 are bonded together by a sealing material 50 such that the surfaces on which such wiring 14 and 24 is formed face each other. The sizes of the two glass substrates 10 and 20 are substantially the same in plan view, and the two glass substrates 10 and 20 are bonded together in a state in which these glass substrates are shifted in the direction of the longer side by a predetermined length L1 as shown in FIG. 4. Note that for the sake of convenience of illustration, FIG. 4 is depicted with the second glass substrate 20 being shifted slightly to the right side in plan view. Moreover, a configuration is also possible in which the two glass substrates 10 and 20 are bonded together in a state of being shifted in the direction of the shorter side.

The first glass substrate 10 is called a “TFT substrate,” “array substrate,” “TFT array substrate,” or the like, and TFTs, pixel electrodes, and the like that are disposed in a matrix are formed on a mother glass substrate. The second glass substrate 20 is called a “color filter substrate,” “opposite substrate,” or the like, and RGB colored layers, transparent electrodes, and the like are formed on a mother glass substrate. Note that the wiring resistance for the wiring 24 formed on the second glass substrate 20 is typically greater than the wiring resistance for the wiring 14 formed on the first glass substrate 10.

FIG. 5 is a schematic plan view for illustrating the configuration of regions outside the display area 82 in the present embodiment. As described above, the first glass substrate 10 and the second glass substrate 20 are formed in substantially the same size in plan view and bonded together in a state of being shifted in the direction of the longer side. Because of this, a first frame area 12 is provided on the first glass substrate 10, and a second frame area 22 is provided on the second glass substrate 20. The region where the first glass substrate 10 and the second glass substrate 20 face each other (the inner region bonded together by the sealing material 50) constitutes the display area 82 for image display. Note that for the sake of convenience of illustration, both the first frame area 12 and the second frame area 22 are depicted toward the front in FIG. 5.

In the present embodiment, pads (electrodes) 60 are provided in both the first frame area 12 and the second frame area 22, as shown in FIG. 5. There are no particular restrictions on the number, size, shape, and the like of these pads 60 provided in the first frame area 12 and the second frame area 22. These pads 60 are used, for example, as pads for mounting components such as a liquid crystal drive circuit, sensor chip, and FPC, or as pads for inspecting this liquid crystal panel. In addition, as described above, the wiring resistance for the wiring 24 formed on the second glass substrate 20 is typically greater than the wiring resistance for the wiring 14 formed on the first glass substrate 10. Therefore, the effect of the wiring resistance is taken into account especially for components to be connected to the pads 60 in the second frame area 22. Note that the “pads” here refer to portions of the wiring formed on the substrates that are not covered by a passivation film (i.e., the portions exposed to the substrate surface).

With the present embodiment, the frame area size becomes nearly two times larger than in the conventional art. Furthermore, the pads 60 are provided in both the first frame area 12 and the second frame area 22. Therefore, more components can be mounted on the glass substrates constituting the liquid crystal panel than in the conventional art. Here, the reason that the frame area size becomes nearly two times larger than in the conventional art is that the portion that has conventionally been discarded is utilized as the second frame area 22. Accordingly, more components can be mounted on the glass substrates than in the conventional art without reducing the number of the panel pieces to be taken from a large panel. Consequently, components that have conventionally been mounted on an FPC or the like can be mounted on the glass substrates, so the size of the FPC or the like can be made smaller than in the conventional art. As a result, the cost is reduced.

### 2.2 Second Embodiment

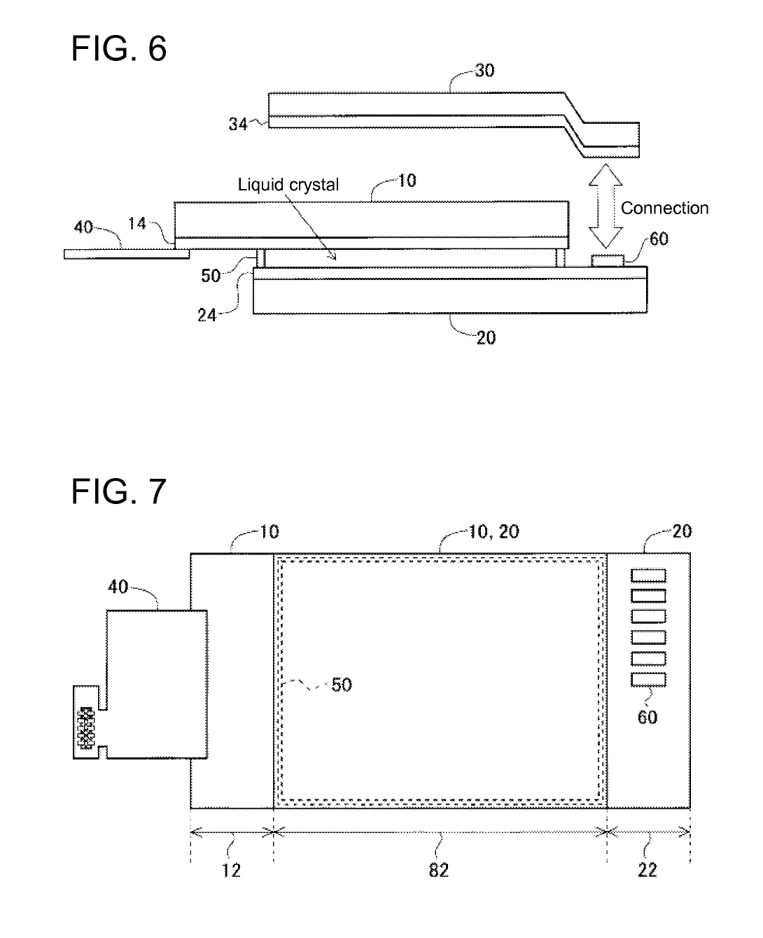

FIG. 6 is a sectional view of a liquid crystal panel according to a second embodiment of the present invention. FIG. 7 is a schematic plan view for illustrating the configuration of regions outside the display area 82 in the present embodiment. Hereinafter, only the differences from the aforementioned first embodiment will be described.

An FPC 40 is connected to the first frame area 12. In such a configuration, for example, a circuit for driving the liquid crystal (liquid crystal drive circuit) is formed monolithically in the first frame area 12, and a controller for controlling the action of the liquid crystal drive circuit is mounted on the FPC 40. Note that the connection between the first frame area 12 and the FPC 40 is accomplished, for example, by interposing an anisotropic conductive film (ACF) between both of the electrodes.

Meanwhile, as shown in FIG. 6, a third substrate 30 that is a substrate other than the substrates constituting the liquid crystal panel is connected to the pads 60 provided in the second frame area 22. The third substrate 30 is a substrate for a mobile phone, for example, and wiring (electrical wiring) 34 is formed on this substrate. Note that zebra connectors, for instance, are used for the connection between the third substrate 30 and the pads 60 within the second frame area 22.

With the present embodiment, as in the aforementioned first embodiment, the frame area size becomes nearly two times larger than in the conventional art, which makes it possible to mount many components on the glass substrates constituting the liquid crystal panel. Moreover, the second frame area 22 is connected to the third substrate 30 having the wiring 34. Therefore, it is possible to devise a configuration in which control signals are supplied to the components mounted in the second frame area 22 via the wiring 34 formed on the third substrate 30, instead of taking a configuration in which control signals are supplied, for example, from the FPC 40 via the wiring 14 and 24 within the panel. Consequently, control signals are supplied to the components within the second frame area 22 via the wiring 34 that has a smaller resistance than the wiring 14 and 24 within the panel, so power consumption is suppressed.

### 2.3 Third Embodiment

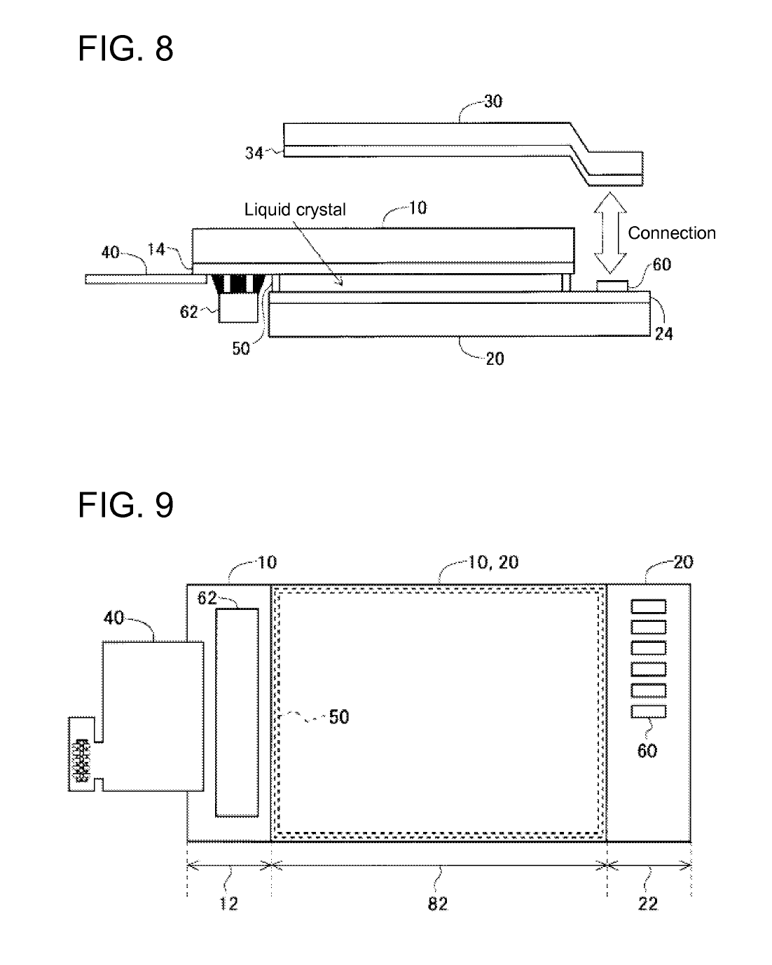

FIG. 8 is a sectional view of a liquid crystal panel according to a third embodiment of the present invention. FIG. 9 is a schematic plan view for illustrating the configuration of regions outside the display area 82 in the present embodiment. In the present embodiment, an IC chip 62 is mounted in the first frame area 12. The configuration other than that is the same configuration as in the aforementioned second embodiment. In such a configuration, for example, an IC for driving the liquid crystal is mounted as the IC chip 62 in the first frame area 12, and a controller for controlling the action of the IC for driving the liquid crystal is mounted on the FPC 40. Note that as a method for mounting the IC chip 62 in the first frame area 12, flip-chip mounting is adopted in which the pads within the first frame area 12 and the bumps on the IC chip 62 are directly bonded, for example.

### 2.4 Fourth Embodiment

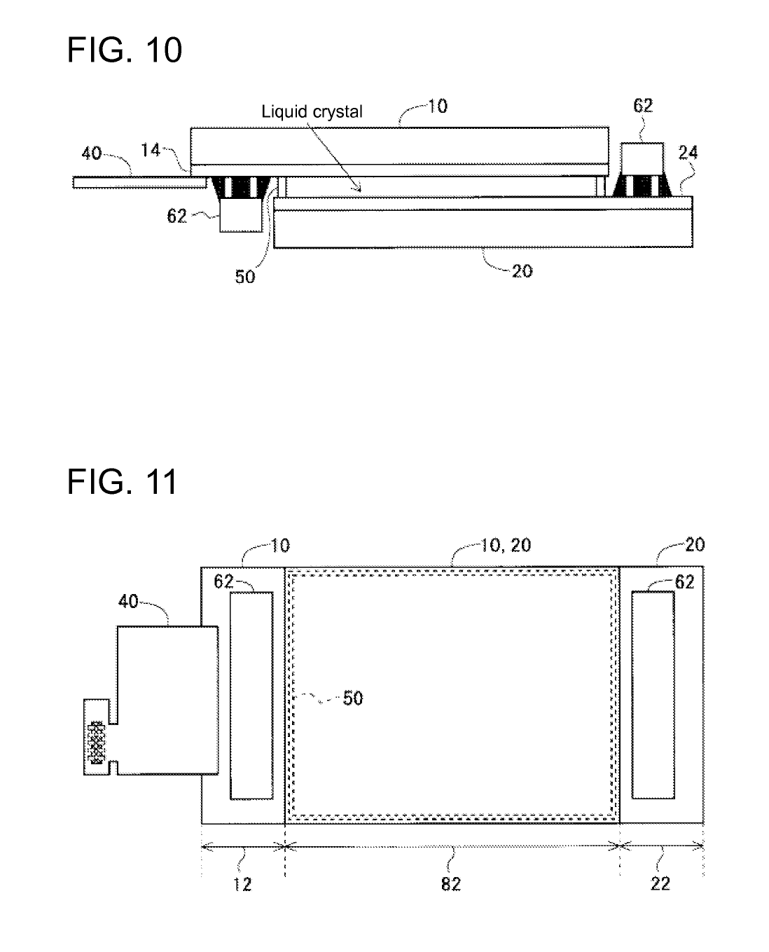

FIG. 10 is a sectional view of a liquid crystal panel according to a fourth embodiment of the present invention. FIG. 11 is a schematic plan view for illustrating the configuration of regions outside the display area 82 in the present embodiment. In the present embodiment, an IC chip 62 is mounted in the second frame area 22. The configuration on the side of the first frame area 12 is the same configuration as in the aforementioned third embodiment. That is, the present embodiment takes on a configuration in which the IC chips 62 are mounted in both the first frame area 12 and the second frame area 22. Note that a configuration is also possible in which a third substrate (e.g., a substrate for a mobile phone) 30 is additionally connected to the second frame area 22 as in the aforementioned second embodiment.

### 2.5 Fifth Embodiment

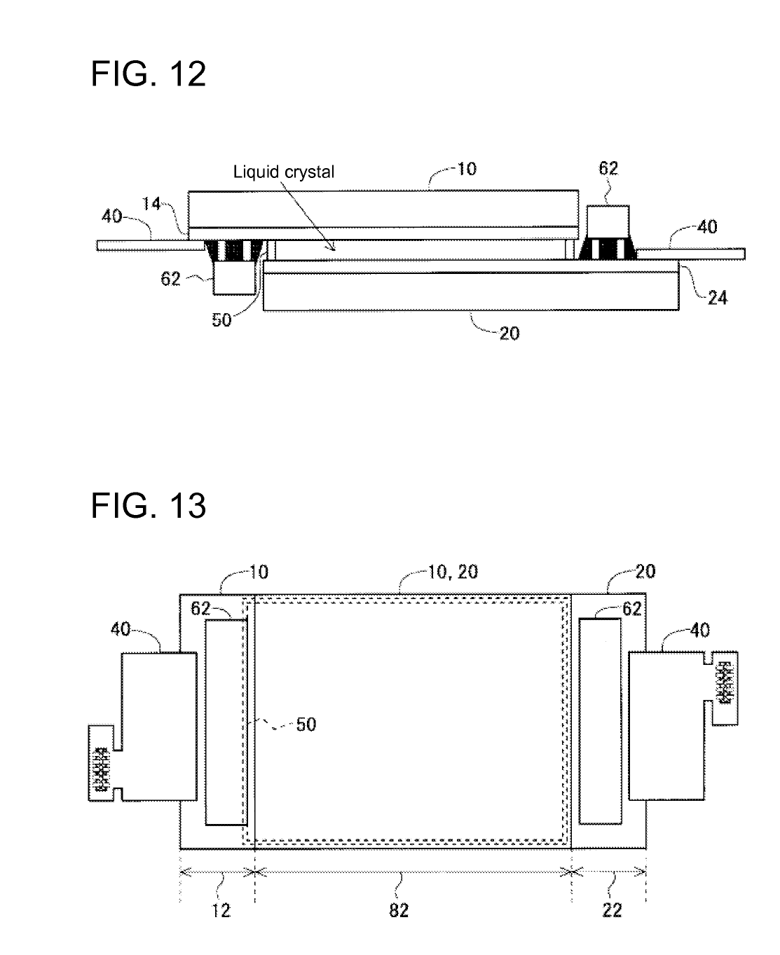

FIG. 12 is a sectional view of a liquid crystal panel according to a fifth embodiment of the present invention. FIG. 13 is a schematic plan view for illustrating the configuration of regions outside the display area 82 in the present embodiment. In the present embodiment, IC chips 62 are mounted in both the first frame area 12 and the second frame area 22, and FPCs 40 are connected to both the first frame area 12 and the second frame area 22. Note that because the wiring resistance on the second glass substrate 20 is relatively high as described above, it is preferable to dispose the IC chip 62 and the FPC 40 in positions that are as close as possible to each other in the second frame area 22. Furthermore, it is also possible to devise a configuration in which a third substrate (e.g., a substrate for a mobile phone) 30 is additionally connected to the second frame area 22 as in the aforementioned second embodiment.

### 2.6 Sixth Embodiment

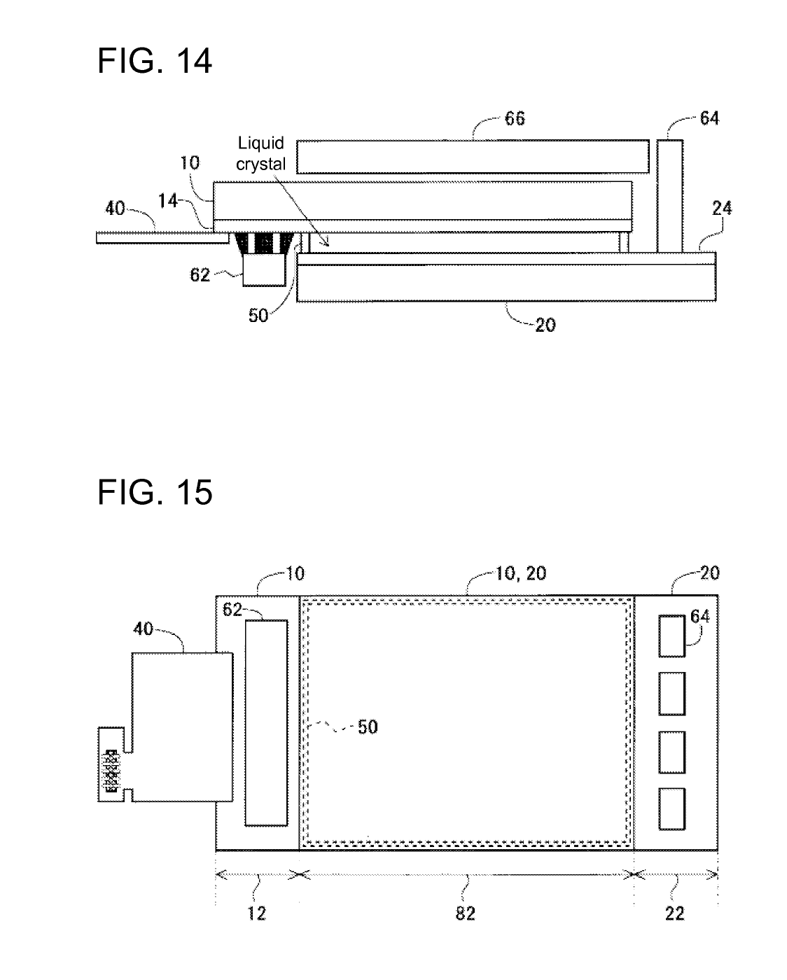

FIG. 14 is a sectional view of a liquid crystal panel according to a sixth embodiment of the present invention. FIG. 15 is a schematic plan view for illustrating the configuration of regions outside the display area 82 in the present embodiment. In the present embodiment, light-emitting diodes (LEDs) 64 are mounted in the second frame area 22. Moreover, as shown in FIG. 14, a light guide plate 66 is provided on the back surface side of the first glass substrate 10 (on the side opposite from the surface on which the wiring 14 is formed). The LEDs 64 function as the light source of the backlight of this liquid crystal panel, and light emitted from the LEDs 64 passes inside the light guide plate 66 and irradiates the display area 82 of this liquid crystal panel from the side of the first glass substrate 10 toward the second glass substrate 20. The configuration on the side of the first frame area 12 is the same configuration as in the aforementioned third embodiment.

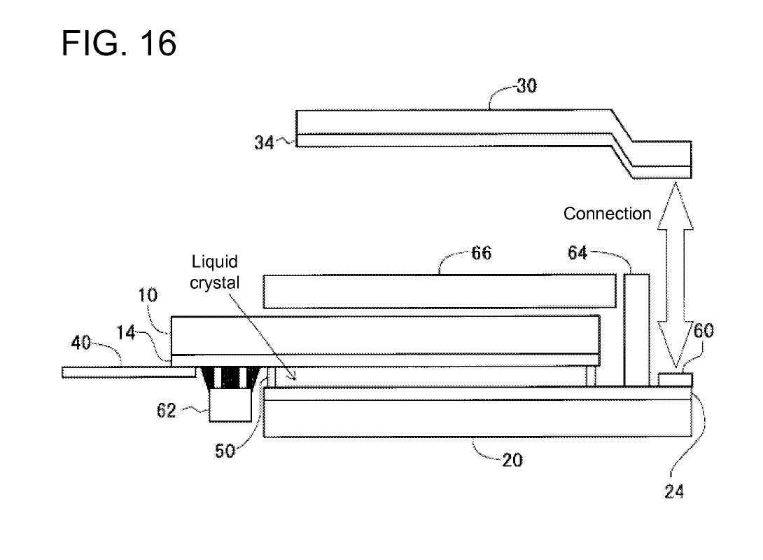

Here, with regard to the control signals that control the lighting conditions of the LEDs 64, it is preferable to adopt a configuration such as the one shown in FIG. 16 as in the aforementioned second embodiment and to supply these control signals to the LEDs 64 via the wiring 34 formed on the third substrate 30. Consequently, the control signals are supplied to the LEDs 64 mounted in the second frame area 22 via the wiring 34, which has a smaller resistance than the wiring 14 and 24 within the panel. As a result, power consumption is reduced (compared to a configuration in which the control signals are supplied to the LEDs 64 via the wiring 14 and 24 within the panel).

### 2.7 Seventh Embodiment

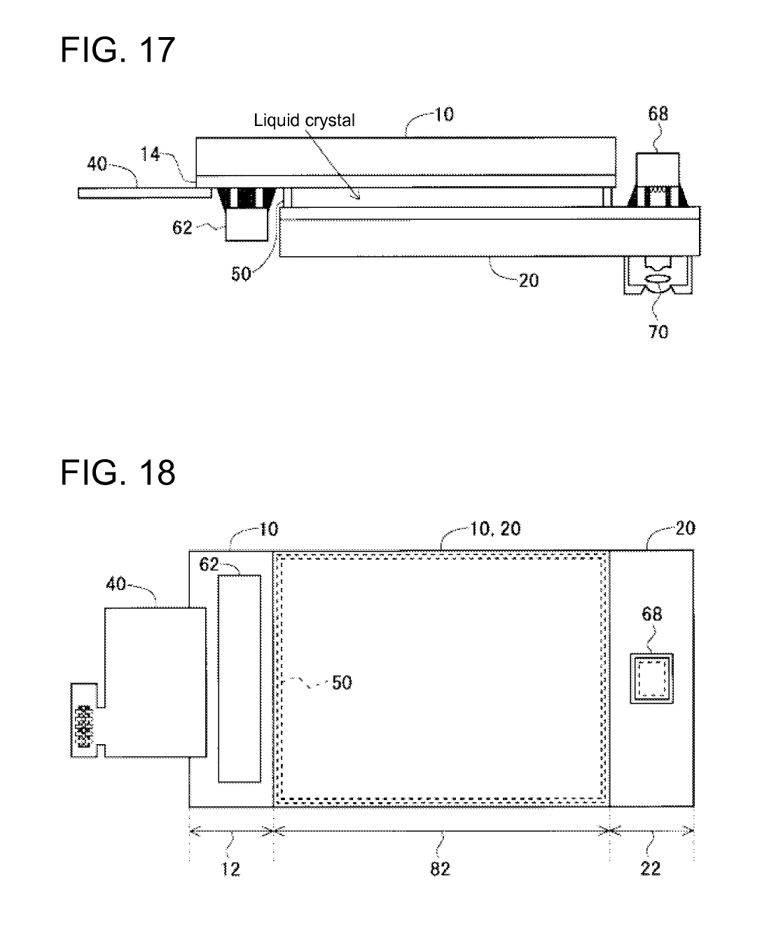

FIG. 17 is a sectional view of a liquid crystal panel according to a seventh embodiment of the present invention. FIG. 18 is a schematic plan view for illustrating the configuration of regions outside the display area 82 in the present embodiment. In the present embodiment, a sensor chip 68 is mounted in the second frame area 22. Moreover, a lens 70 for focusing light is mounted on the back surface side of the second glass substrate 20 (on the side opposite from the surface on which the wiring 24 is formed). By providing such a sensor chip 68 and lens 70, camera functions are realized. The configuration on the side of the first frame area 12 is the same configuration as in the aforementioned third embodiment.

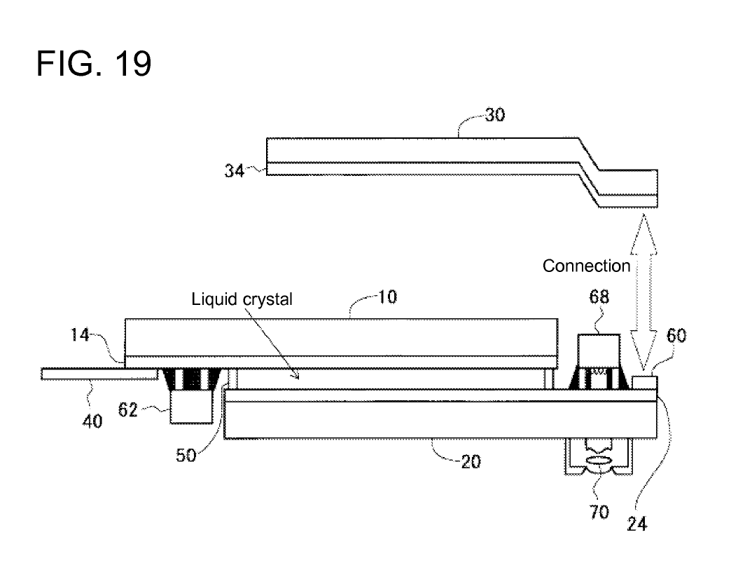

Here, with regard to the exchange of input and output signals between the sensor chip 68 and a control portion or the like, it is preferable to adopt a configuration such as that shown in FIG. 19 as in the aforementioned second embodiment and to accomplish this exchange via the wiring 34 formed on the third substrate. Consequently, power consumption can be reduced as in the aforementioned sixth embodiment.

### 2.8 Eighth Embodiment

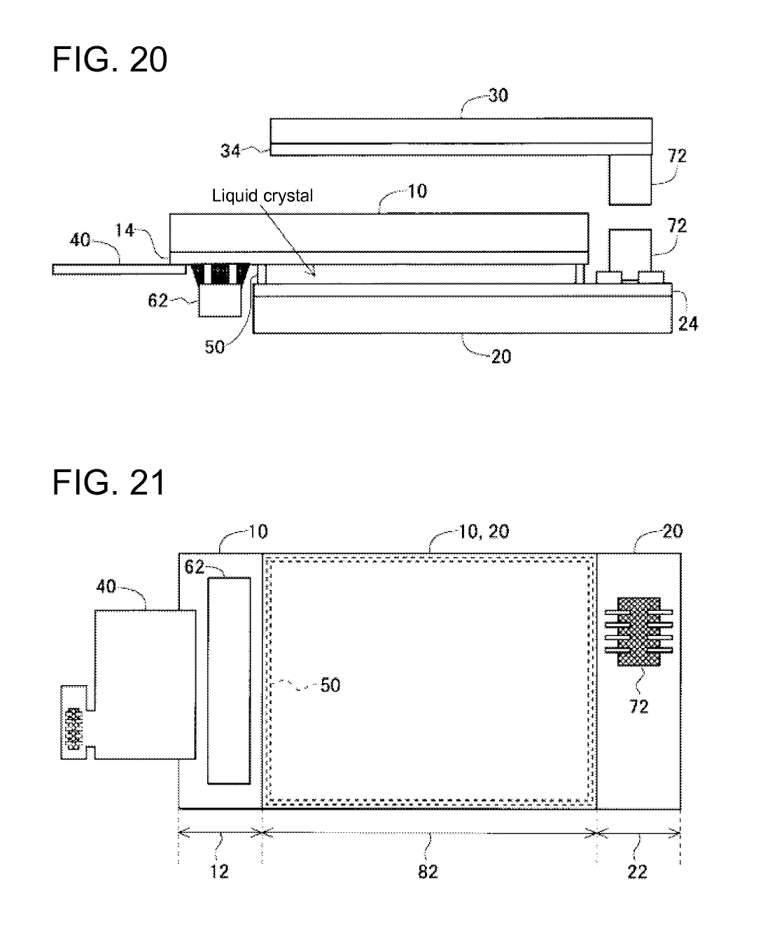

FIG. 20 is a sectional view of a liquid crystal panel according to an eighth embodiment of the present invention. FIG. 21 is a schematic plan view for illustrating the configuration of regions outside the display area 82 in the present embodiment. In the present embodiment, the second frame area 22 is connected to the third substrate 30 by board-to-board connectors 72 called “B-to-B connectors.” The configuration on the side of the first frame area 12 is the same configuration as in the aforementioned third embodiment.

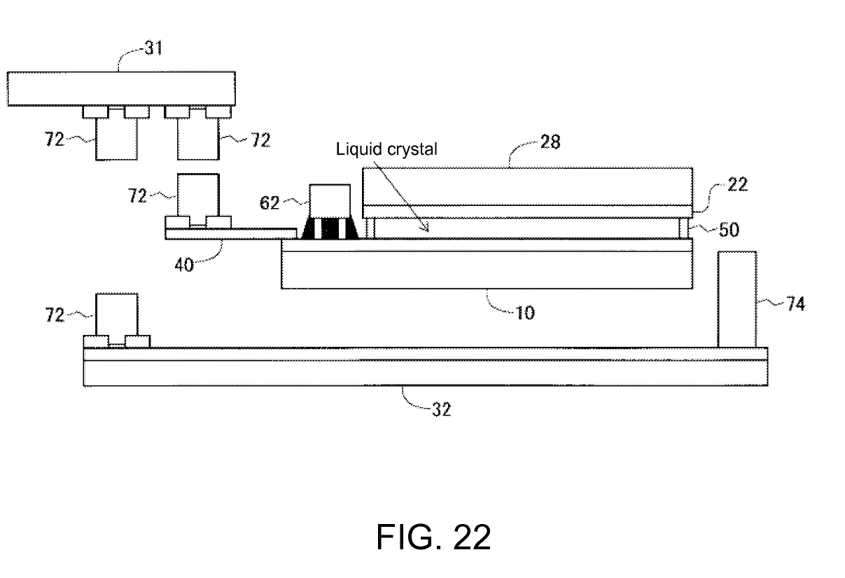

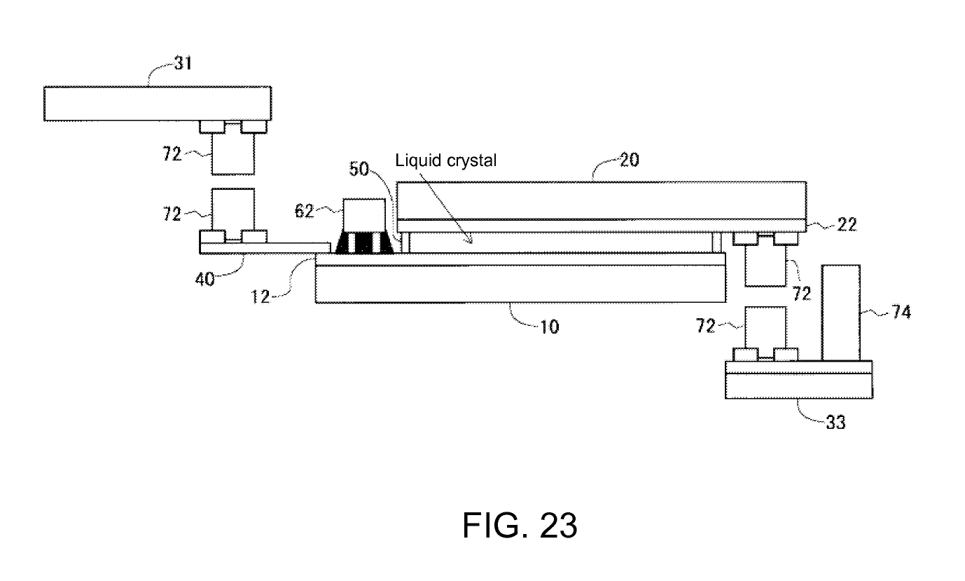

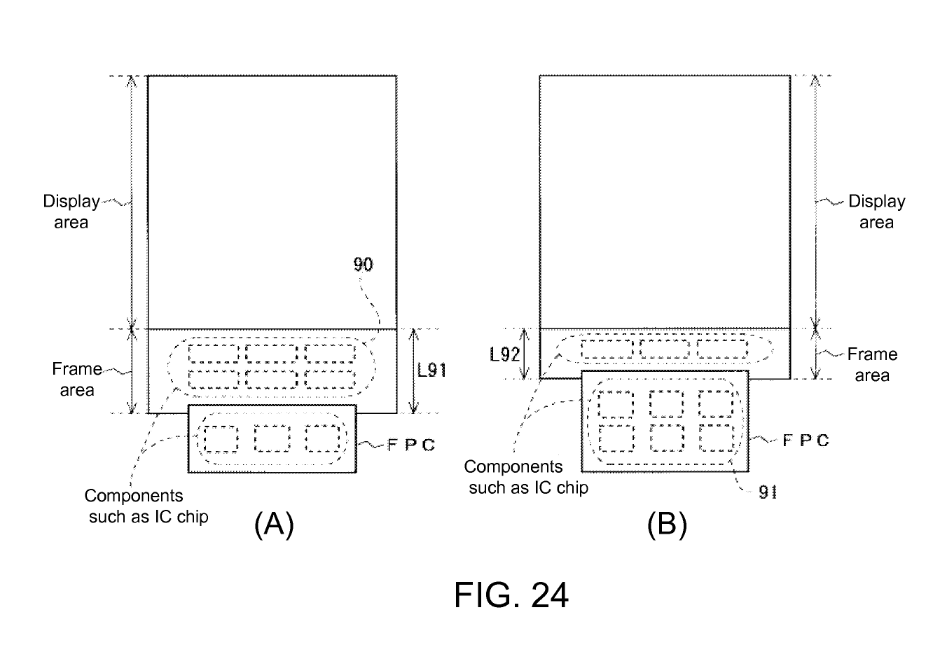

Here, with regard to a mobile phone having a liquid crystal panel, there are cases in which a component such as a speaker or indicator is disposed in a position away from the main board (for the mobile phone) (for example, the main board is disposed in the vicinity of one end of the liquid crystal panel in the direction of the longer side, while such a component is disposed on the other end). In such cases, in the conventional art, a substrate (hereinafter referred to as “sub-board”) having a length substantially equal to or greater than the distance of the liquid crystal panel in the direction of the longer side was prepared, and a speaker 74, for instance, was mounted in the vicinity of one end of this sub-board 32, while the vicinity of the other end of this sub-board 32 was connected to a main board 31 via board-to-board connectors 72, as shown in FIG. 22. With the present embodiment, on the other hand, it is possible to devise a configuration in which the vicinity of the other end of a sub-board 33 and the second frame area 22 of the liquid crystal panel are connected by board-to-board connectors 72, as shown in FIG. 23. That is, as can be grasped from FIGS. 22 and 23, with the present embodiment, the length of the sub-board for the mobile phone can be reduced considerably, as compared to the conventional art. This makes it possible to achieve the lowering of the profile and the reduction in cost of a mobile phone having a liquid crystal panel.

### 3. Others

Each of the aforementioned embodiments exemplifies a configuration in which various types of component (such as an IC chip 62) are mounted in the first frame area 12 and the second frame area 22, but the present invention is not limited to such exemplified configurations. As long as the configuration is such that frame areas are provided on different substrates at one end and the other end of the liquid crystal panel, various types of component may be mounted in each of the frame areas in a combination different from those of the configurations exemplified in the aforementioned respective embodiments, or components other than the components exemplified in the aforementioned respective embodiments may be mounted in each of the frame areas.

In addition, in each of the aforementioned embodiments, zebra connectors or B-to-B connectors (board-to-board connectors) are exemplified as the connecting members for connecting a substrate for a mobile phone and a glass substrate with which the liquid crystal panel is configured. However, the present invention is not limited to this, and these substrates may also be connected by other connecting members.

### DESCRIPTION OF REFERENCE CHARACTERS

10 first glass substrate
12 first frame area
14, 24, 34 wiring
20 second glass substrate
22 second frame area
30 third substrate
40 FPC
50 sealing material
60 pad (electrode)
62 IC chip
64 LED
66 light guide plate
68 sensor chip
70 lens
72 board-to-board connector (B-to-B connector)
74 speaker

1. A liquid crystal panel, comprising: a first substrate having a first wiring surface on which electrical wiring is formed; and a second substrate having a second wiring surface on which electrical wiring is formed, said first substrate and said second substrate being bonded with each other such that a portion of a region on said first wiring surface and a portion of a region on said second wiring surface face each other,
wherein said second wiring surface is formed in substantially the same size as said first wiring surface, and
wherein said first wiring surface and said second wiring surface face each other with a liquid crystal therebetween in a state in which these wiring surfaces are shifted from each other by a predetermined distance in the direction of a longer side or in the direction of a shorter side.

2. The liquid crystal panel according to claim 1, wherein one or more electrodes are provided in both a first frame region, which is, in the region on said first wiring surface, a region that does not face said second wiring surface, and a second frame region, which is, in the region on said second wiring surface, a region that does not face said first wiring surface.

3. The liquid crystal panel according to claim 2, wherein said first wiring surface and said second wiring surface are formed such that a wiring resistance in said second wiring surface is greater than a wiring resistance in said first wiring surface, and
wherein a circuit for driving said liquid crystal is formed in said first frame region.

4. The liquid crystal panel according to claim 2, wherein at least one of the electrodes provided in said second frame region is connected to a third substrate having electrical wiring.

5. The liquid crystal panel according to claim 4, wherein a light-emitting diode is provided in said second frame region, and said light-emitting diode and said third substrate are electrically connected via the electrical wiring formed on said second wiring surface.

6. The liquid crystal panel according to claim 4, wherein a sensor chip is provided in said second frame region, and said sensor chip and said third substrate are electrically connected via the electrical wiring formed on said second wiring surface.

7. The liquid crystal panel according to claim 2, wherein at least one of the electrodes provided in said first frame region is connected to a flexible printed board.

8. The liquid crystal panel according to claim 2, wherein at least one of the electrodes provided in said second frame region is connected to an integrated circuit chip.

9. The liquid crystal panel according to claim 2, wherein at least one of the electrodes provided in said second frame region is connected to a flexible printed board.

10. The liquid crystal panel according to claim 2, wherein at least one of the electrodes provided in said first frame region is connected directly or via a flexible printed board to a fourth substrate which is a main board for communication functions, and
wherein at least one of the electrodes provided in said second frame region is connected directly or via a flexible printed board to a fifth substrate which is a sub-board on which a component for communication functions is mounted.
